(19) United States
(12) Patent Application Publication
(10) Pub. No.: US 2023/0385537 A1
(43) Pub. Date: Nov. 30, 2023

(54) ARTIFICIAL INTELLIGENCE SMART AUTOCOMPLETE

(71) Applicant: Bank of America Corporation, Charlotte, NC (US)

(72) Inventors: Ramakrishna R. Yannam, The Colony, TX (US); Ravisha Andar, Plano, TX (US); Priyank R. Shah, Plano, TX (US)

(21) Appl. No.: 17/825,206

(22) Filed: May 26, 2022

(51) Int. Cl. G06F 40/174; G06F 40/274; G06K 9/62; G06F 11/34

(52) U.S. Cl. CPC G06F 40/174; G06F 40/274; G06K 9/6256; G06F 11/3438; G06N 20/00

(57) ABSTRACT

This application describes apparatus and methods for providing artificial intelligence (“AI”) autocomplete that locates functionality within an application based on a search string entered by a user. The AI system may track activity of the user within one or more applications. Based on the user activity, the AI system may formulate a set of training data. The AI system may train an AI model based on the training data. After training the AI model, the AI system may detect user entry of the search string into a search function. The AI system may apply the AI model to present a target output associated with the application that is personalized for the user.

### FIELD OF TECHNOLOGY

This application describes apparatus and methods for providing artificial intelligence (“AI”) autocomplete that locates functionality of an application in response to a user entered search string.

### BACKGROUND

Mobile applications or “apps” are an ever-present part of our connected lives. Available apps currently provide a wide variety of functions and services from controlling features in a car, music streaming, management of finances, planning of travel, fitness regimes and facilitating social media interactions.

About 218 billion mobile apps were downloaded to user's connected devices in 2020 from the multiple app “stores” or marketplaces. An average user accesses 9 apps per day and about 30 apps per month. It is estimated that about 70% of all U.S. digital media time is spent using mobile apps and 49% of users open an app 11+ times each day.

The number of smartphone users is expected to reach 4.3 billion by 2023. This increased smartphone usage is expected to lead to a concomitant increase in the number of apps to service the needs of mobile device users. This expected proliferation of apps will exacerbate a problem of remembering which app provides which functionality or locating a desired functionality within an app.

Users download so many apps because they each provide different functionality. Collectively, a user's apps may provide functionality that allows the user to accomplish daily tasks more efficiently. In addition to the multitude of apps, each of the apps may provide multiple functions. Each of the apps may have different labels or descriptions of functions provided by the app. Internally, each of the apps may organize their respective functions within different menu hierarchies.

A user frequently has to remember the different terminology to locate functionality within each app. Additionally, the user has to remember the menu lineage to successfully locate a desired function within an app. Sometimes a user may only recall what was accomplished by the app and will not recall the specific label assigned to the function within the app.

It would be desirable to provide a search function that would allow a user to input a search string and locate a target app functionality. It would be desirable to allow the search function to locate an app function based on a task the user wishes to accomplish. It would be desirable to allow the search function to locate an app function based on a how often the user accesses a desired function or based on whether the search string includes input values typically used when accessing the desired function. Accordingly, there is a need for ARTIFICIAL INTELLIGENCE SMART AUTOCOMPLETE.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows an illustrative system in accordance with principles of the disclosure;

FIG. 4 shows operation of an illustrative prior-art system;

FIG. 5 shows operation of an illustrative system in accordance with principles of the disclosure;

FIG. 6 shows operation of an illustrative system in accordance with principles of the disclosure;

FIG. 7A shows operation of an illustrative system in accordance with principles of the disclosure;

FIG. 7B shows operation of an illustrative system in accordance with principles of the disclosure; and

FIG. 8 shows operation of an illustrative system in accordance with principles of the disclosure.

### DETAILED DESCRIPTION

Apparatus for an artificial intelligence (“AI”) system for auto-completing user entry of a search term into a search function is provided. The search term may include a single character. The search term may be a string of characters. The search term may not be a distinct or meaningful word. The system may include machine executable instructions. The machine executable instructions may be stored on a non-transitory medium. The machine executable instructions, that when executed by a processor on a computer system may implement functionality of the AI system.

Today, when a user enters a search string into a search function, prior art systems may generate an automated list of terms that may be of interest to the user. For example, as soon as the user enters one or more characters, the automated list may include terms that complete a word or phrase that begins with the characters entered into the search function. A single app may be downloaded many times by many different users. The app may track searches performed by all users of the app.

When a user enters a search string, the automated list provided in response to the user entered search string may be generated based on functions or service that are commonly searched by all app users. For example, in a banking app, if a search string includes the characters “acc,” the app may display a link to an “account balance” function. If the search string includes the characters “cc,” the app may be configured to display a link to view credit card accounts.

However, the autogenerated list of search results are not user specific and are not tailored based on a specific user's app activity. Therefore, prior art systems typically provide search results that are not relevant to a specific user. The AI system disclosed herein may tailor search results based on a specific user's activity. The AI system may generate autocomplete suggestions to a user's search query that are “smart.” “Smart” search results may be personalized and unique to a user.

Smart results may be determined based on the user's frequent activity, navigation, transactions and outside websites the user visits. The smart suggestions generated by the AI system may be presented to the user as soon as the user begins typing a query into a search function. The AI system may rank potential search results in order of popularity or most frequently activated function for the user performing the search. The AI system take account of a user's transactional data, account data and activity when generating search results for the user.

The AI system may provide personalized search results based on a specific user's past activity and based on the user's real-time interactions within an app. The AI system may include computer programs that process datasets to enable problem-solving by computer systems. Computer systems that are AI enabled may perform problem-solving tasks that typically require human-like intelligence. Illustrative AI computational algorithms may include AdaBoost, Naive Bayes, Support Vector Machine, Random Forests, Artificial Neural Networks and Convolutional Neural Networks. An illustrative AI system may include machine and deep learning algorithms.

Machine learning AI systems are programmed to identify patterns in data sets and make decisions based on the patterns. Machine learning algorithms are typically used to predict future behavior based on historical patterns. By providing new and updated data, machine learning AI systems may improve their predictions. However, even though machine learning AI systems may improve their predictions, such systems only detect patterns based on how they are pre-programmed to review provided data. Machine learning systems do not adapt on their own to look at data in different ways or flag patterns in the data they were not pre-programmed to search for.

On the other hand, deep learning AI systems adapt when exposed to different patterns of data. Deep learning AI systems may uncover features or patterns in data that they were never specifically programmed to find or search for. Deep learning AI system are typically based on neural networks. A neural network takes an input and passes the input through a network of neurons — called layers—and provides an output. The more layers of neurons part of the network, the “deeper” the network. A neural network learns from outputs flagged as erroneous and “adapts” its neuron connections such that the next time it receives a particular input it generates a relevant output.

Neural network must undergo training by analyzing data sets. Neural networks learn from the training data sets provided to them and rearrange interconnections between the neurons in response to training data. The strength or weight of connections between the neurons or layers can vary. A connection between two or more layers can be strong, weak or anywhere in between. When a neural network self-adapts it adjusts the strength of the connections among its neurons to generate more accurate outputs.

To get a neural network to provide accurate outputs, neuron connections are adjusted by repeatedly training the network by exposing it to training data sets. There can be thousands and millions of neurons or layers in a network and adjusting their connections between the layers is a compute-intensive matrix-based mathematical procedure.

Typically, training of deep learning AI systems is performed using Graphics Processing Unit (“GPU”) clusters of servers. A GPU is hardware capable of performing math computations over a huge amount of data at the same time. GPU's do not operate as fast as central processing units (“CPUs”). However, GPUs are capable of processing larger quantities of data per unit of time. Thus, even though each individual GPU operation may execute more slowly, applying computational operations to more data in parallel exceeds CPU performance, allowing AI system to be fully trained faster.

The training phase may go on for several iterations until the outputs of the AI system are satisfactory and accurate. Once that happens, the trained neural network is released to production on less powerful hardware. Data processed after the AI system is in production can be fed back into the neural network to correct it or enhance output according to the latest trends detected in newly acquired data sets. Therefore, the process of training and retraining a neural network can occur iteratively over time. A neural network that is not retrained will become inaccurate with respect to new data sets.

The AI system may track user activity within one or more apps. An app is a computer program that operates on a computer system. The computer system may be a desktop computer, mobile device wearable device or any suitable computer system. Each app may provide a suite of functions to the user. Exemplary apps include web browsers, e-mail programs, word processors, and utilities.

User activity within an app may be tracked. The user activity may be tracked during a training period. The AI system may formulate a set of training data based on the user activity. The user activity may include the user's past usage of the app. For example, the user activity may include transactions initiated by the user, data accessed by the user, and current account status that is available within the app.

The user activity may include navigation within the app to locate a plurality of functions provided by the app. For example, within a banking app, the user may typically view an account summary and then search for a particular transaction of interest. The AI system may determine that when the user searches for a transaction after viewing the account summary, the user typically searches for a transaction having a target value.

At other times, the user may access a search function from a home screen associated with an app. The home screen of an app may provide an introductory interface from which the user can access functionality of the app. The AI system may determine that when the user searches for a transaction from the home screen, the user typically searches for a transaction having a target vendor name. When the user searches for a transaction directly from the home screen, the AI system may present search results ordered based on vendor name. The AI system may determine that when the user searches for a transaction after viewing an account summary, the user typically searches for a transaction based on value. When the user searches for a transaction after viewing an account summary, the AI system may present search results ordered based on transaction value.

The user activity monitored by the AI system may include text or character strings entered into an app by a user. The user may enter text or character strings when interacting with a function provided by the app. The user activity monitored by the AI system may include an execution frequency associated with each of a plurality of functions provided by an app.

For example, user_1 may use a first app function (e.g., account transfer) more frequently than user_2. When user_1 enters the search term “tra” into a search function, the AI system may present user_1 with a link to the first app function. On the other hand, user_2 may use a second app function (e.g., view recent transactions) more frequently than user_1. When user_2 enters the search term “tra” into a search function, the AI system may present user_2 with a link to the second app function.

The AI system may train an AI model, such as neural network, using training data. Training the AI model may include creating connections between neurons or lays that link user input provided to the app to a function implemented by the app. The AI system may include a trained AI model. The AI system may detect entry of a search term into the search function provided by an app. The AI system may apply a trained AI model to the search term.

In response to input of the search term, the trained AI model may generate a search result that includes a target function implemented by the app. Search results generated by the AI system may be “smart” results. Smart results are personalized and unique to the user that entered the search term into the search function. The AI system may “autocomplete” the user's search term based on a user's prior activity. The user's prior activity may be associated with the app current being searched or activity of the user within other apps. The AI system may order smart results based on popularity and most active results for a given user. The user's transactional data, account data and any other activity within an application may all be taken into account by the AI system when generating response suggestions to a user's search request.

The AI system may present the target function to the user. The AI system may present the target function to the user within a user interface of an app. For example, the target function may be displayed in a list or other format. The user may click or otherwise select the displayed target function to access the target function.

In an exemplary scenario, a user may type the search term “ret” into a search function provided by an app. The AI system may determine that the user has executed transactions with merchants “retail_1” and “retail_2.” In the generated search results, the AI system may present a link to view recent transactions associated with retail_1 and retail_2.

In some embodiments, the AI system may present a link to recent transactions associated with retail_2 above recent transaction associated with retail_1. The user may execute a higher frequency of transaction with retail_2 relative to retail_1. A description of the target function within the application may not include the search term entered by the user into the search function. For example, the user may enter “ret” and the AI system may determine that the user is most likely interested in recent transactions because the user has previously executed a threshold number of transactions associated with retail_1.

A descriptive label associated with a target function presented by the AI system as a search result may be a text string that does not begin with the same character at the first character of the search term entered by the user. For example, the user may begin typing “ret” and the AI system may understand that the user is looking for to view transactions associated retail_1. The descriptive label associated with the presented search results may not include any characters included in the search term entered by the user into the search function.

Search results presented by the AI system may be different for different users. For example, both user_1 and user_2 may type the term “ret” into a search function of the same application. If user_1 has conducted more transactions associated with retail_2, as the top search results displayed to user_1, the AI system may display a link to view transactions associated with retail_2. If user_2 has conducted transactions associated with retail_1, as the top search result to user_2, the AI system may show recent transactions associated with retail_1.

In response to identifying a target function as top ranked search result for a user, the AI system may navigate directly to an input screen of the target function within the app. Thus, the AI system may be confident that it understands what the user is seeking and may skip the step of displaying any other search results to the user. Instead, the AI system may load an input screen that provides an interface for the user to enter a value associated with the target function. Furthermore, the AI system may pre-fill at least one value into the input screen. The AI system may pre-fill the input value based on historical character strings entered by the user when utilizing the target function.

The AI system may detect a change in execution frequency associated with a target function implemented by an app. In response to detecting the change in frequency, the AI system may initiate a new training period for an AI model included in the AI system. The change in frequency may be detected as a result of feedback provided to the AI model to correct or enhance the AI model according to the latest user activity. The process of training and retraining the AI model may prevents the AI system from becoming inaccurate with respect to newly acquired data sets.

The AI system may dynamically reapply the AI model to a search term in response to each additional character added by the user to the search term. Based on each additional character entered by the user, the AI system may refine displayed search results.

The user may utilize a search function in a first app. The user may enter a search term into the search function. The AI system may formulate a set of training data based on user activity associated with a first app and user activity associated with a second app. In response to the search term entered into the search functionality of the first app, the AI system may train the AI model to generate a target function implemented by the first app based on correlating the entered search term to the user activity associated with the second app.

An artificial intelligence (“AI”) system is provided for generating personalized search results in response to entry of a user query. The AI system may tailor responses to a user's search requests based on the user's personal activity. The AI system may track user activity within an app. Based on the user activity, the AI system may formulate a set of training data.

The set of training data may include a plurality of input terms entered by the user. The input terms may be search queries. The input terms may be values or characters entered when utilizing a functionality of the app. For example, the input terms may be values of account transfers or payment amounts. The input terms may be text strings identifying a vendor, payee or payor.

The set of training data may include a plurality of function labels. Functional labels may include descriptions of app functionality displayed to user. For example, exemplary function labels may include “account transfer,” “bill pay,” “recent transactions,” or “view credit card statement.”

The set of training data may be created based on tracking user navigation within the app during a predetermined time period. The training data may include a frequency of use associated with each of the plurality of terms. The AI model may utilize the frequency when generating the output. The training data may include a frequency of use associated with each of the plurality of functional labels available in an app. The frequency of use may correspond to how often a user accesses a functionality provided by the app. The AI model utilizes the use frequency of each functional label when generating the output.

The AI system may train an AI model based on the training data. The AI system may train the AI model using specialized GPU hardware servers. The AI model may include a neural network. The AI system may include an inference server. After training the AI model, the AI model may be deployed on the inference server which is configured to execute the trained AI model. The inference server may be a CPU-based system. The inference server may be a cloud-based system.

After deploying the AI model, the AI system may detect user entry of a search string into a search function of the app. The AI system may apply the AI model to computer search results that are responsive to the search string and personalized for the user. In response to detecting that the search string entered by the user begins with one of plurality of function labels associated with the app, the search result generated by the AI model may include at least one of the plurality of input terms included in the set of training data.

For example, if the user entered search string includes “account balance,” the search result generated by the AI model may link the user directly to a page for viewing the account balance of a specific account, even though the user has multiple accounts. The specific account may be an account frequently used and the subject of a threshold percentage of transactions requested by the user.

In response to detecting that the search string entered by the user begins with one of the plurality of input terms, the search result generated by the AI model may include at least one of the plurality of function labels. For example, the user may enter “$50.” In response to this input term, the AI model may link the user directly to a page within the app showing recent transactions greater than or equal to $50.

The search result generated by the AI system may include at least one functional label and a user input term associated with the at least one functional label. For example, in response to a user search string of “retail_1,” the AI system may generate a search result showing recent payments (the functional label) of $100 (the input term) to retail_1.

In some embodiments, the search result may include directing the user to an input screen associated with a search result. For example, in response to a user input of “$200,” the AI system may determine that the user is likely searching for a bill pay function. In response to determining that the user is searching for the bill pay function, the AI system may present to the user an input screen for initiating a bill payment. The AI system may pre-fill a field on the input screen. For example, the AI system may prefill an amount field of the bill pay function with a value of $200.

An artificial intelligence (“AI”) method for generating smart search results in response to a search string is provided. The method may include executing machine-readable instructions that are stored on a non-transitory memory. The method may include Executing the machine-readable instructions on a processor of a computer system.

The method may include tracking user activity within an app. The method may include building a user profile based on the user activity. The method may include detecting entry of the search string. Based on the user profile, the method may include locating a target function implemented by the app. The method may include opening a landing page within the app that provides access to the target function. The method may include prefilling at least one field on the landing page based on the user profile.

The app may be a first app. The tracking of the user activity may include tracking a first set of user activity. The first set of user activity may include first user inputs entered into the first application. The first set of user activity may include first outputs generated by the first application in response to the first user inputs. The tracking of user activity may include a second set of user activity. The second set of user activity may include second user inputs entered into a second app. The tracking of user activity may include second outputs generated by the second app in response to the second user inputs.

The method may include building the user profile based on the first set of user activity and the second set of user activity. The method may include locating a target function implemented by the first app based on the second set of user activity. In some embodiments, the first set of user activity may be associated with a first user and the second set of user activity may be associated with a second user. In some embodiments, the first set of user activity and the second set of user activity may be associated with a single user.

The search string may be a numeric value. Based on the user profile, the method may include locating a target function implemented by the app. The method may include applying an AI model to continuously monitor activity of the user. In response to detecting a threshold change in the user activity, the method may include regenerating the user profile based on updated user activity.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

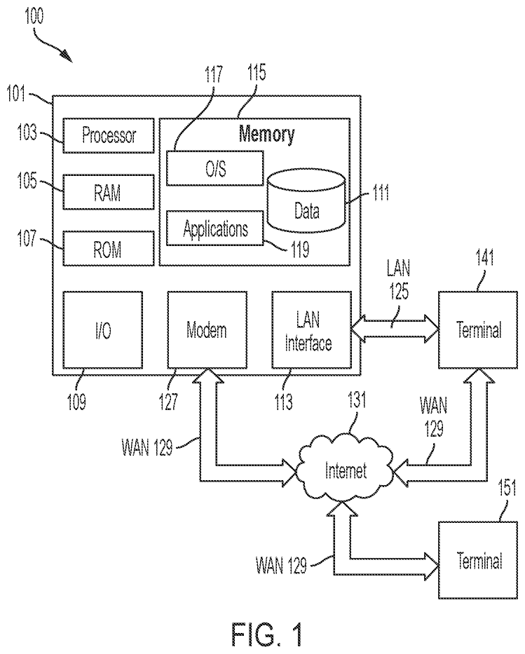

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute software running on the computer. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory. Any information described in connection with data 111, and any other suitable information, may be stored in memory 115.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions. Application program(s) 119 (which may be alternatively referred to herein as “plugins,” “applications,” or “apps”) may include computer executable instructions for invoking functionality related to performing various tasks.

Application program(s) 119 may utilize one or more algorithms that process received executable instructions, perform power management routines or other suitable tasks. Application program(s) 119 may utilize one or more AI models as described herein. Application program(s) 119, which may be used by computer 101, may include computer executable instructions for invoking functionality related to communication, such as e-mail, Short Message Service (SMS), and voice input and speech recognition applications.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

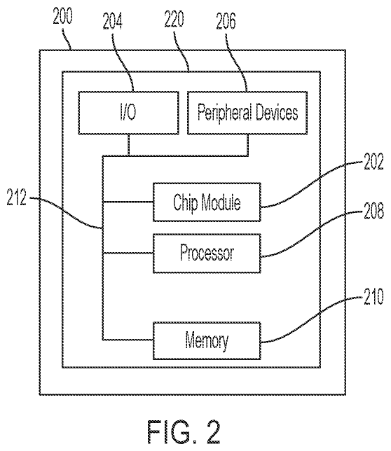

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits. Chip module 202 may be a GPU or configured to perform any other suitable logical operations.

Apparatus 200 includes processor 208, which may include one or more integrated circuits which includes logic configured to process executable instructions associated with an application. Processor 208 which may compute data structural information and structural parameters of the data. Application executed by chip module 202 or processor 208 may be stored in machine-readable memory 210.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, one or more of components 202, 204, 206, 208 and 210 may be integrated into a single chip. The chip may be silicon-based.

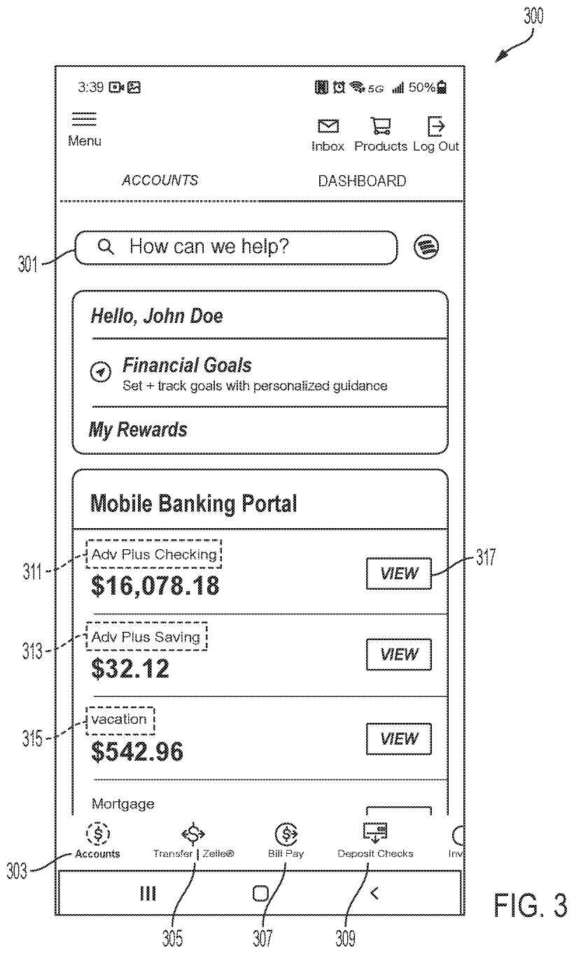

FIG. 3 shows an illustrative home page 300 associated with a mobile banking app. Home page 300 shows search function 301. Search function 301 may be available to a user on any page of mobile banking app 300. A user (e.g., John Doe) may enter characters into search function 301 to locate a function provided by the mobile banking app. Home page 300 shows illustrative functions such as view account transactions 303, transfer funds 305, bill pay 307 and deposit checks 309.

A user may enter a characters into search function 301 that include a partial term of one or more of labels 311 (“Checking”), 313 (“Saving”), and 315 (“vac”). A user may enter characters into search function 301 that includes a partial term of function label 317 (“v”). When a user enters “v,” an AI model may be capable of determining whether the user is more likely looking to view transactions associated with account 311, 313 or 315.

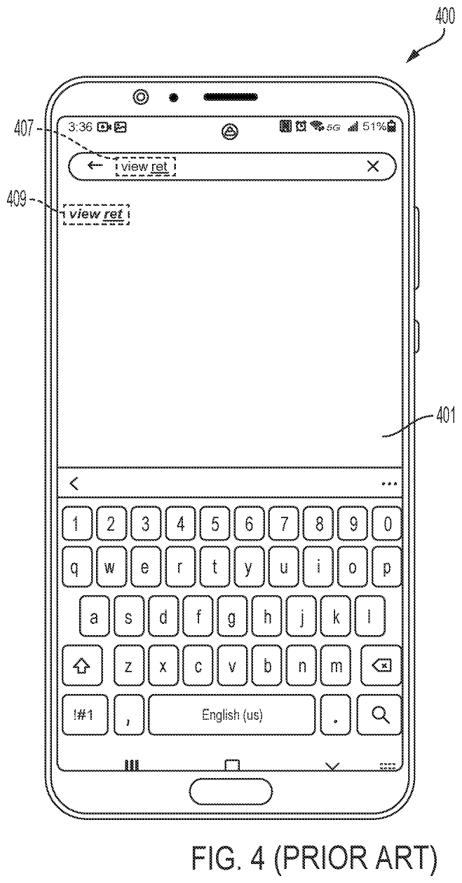

FIG. 4 shows illustrative prior-art scenario 400. FIG. 4 shows that a user has accessed search function 301 entered search term “view ret.” Scenario 400 shows that search function 301 has not found any relevant results and has simply displayed user input 409 on results page 401. Search function may have not found any results because the prior art mobile banking app may not have any functions or labels that include the characters “ret.”

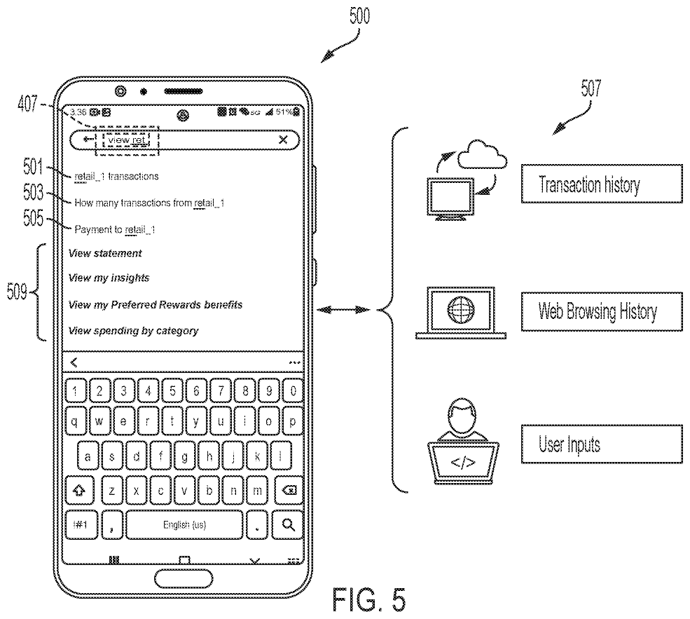

FIG. 5 shows illustrative scenario 500 in accordance with the principles of this disclosure. Scenario 500 shows that an AI system has processed search term 407 (“view ret”) entered into search function 301. Scenario 500 shows that the AI system has generated “smart” outputs 501, 503 and 505. Output 501 shows that the AI system has determined the user is likely interested in viewing transactions associated with a vendor called “retail_1.” Output 503 shows that the AI system has determined that the user is also likely interested in how many transaction have recently been executed in connection with the vendor “retail_1.” Output 505 shows that the AI system has determined that the user is likely interested viewing recent payment made to the vendor “retail_1.”

The “smart” outputs 501, 503 and 505 may be generated based on training data 507 provided to an AI model included in an AI system. FIG. 5 shows that training data 507 may include transaction history associated with use of mobile banking app 300 and a web browsing history. A web browser may be provided to the user via a different application other than the mobile banking app. Training data 507 may include user inputs. User inputs may be entered by the user into the mobile banking app or any another app.

Search results 501, 503 and 505 are “smart” search results that are personalized based on activity of a specific user. FIG. 5 also shows that search results 509 may also be presented to the user. Search results 509 are not personalized based on activity of a specific user.

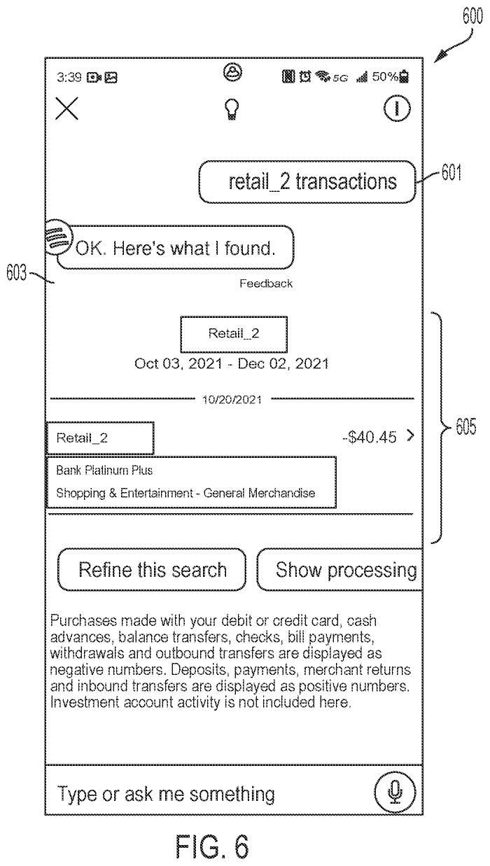

FIG. 6 shows illustrative scenario 600 in accordance with the principles of this disclosure. Scenario 600 shows that a user has entered input 601 into a chatbot function provided by a mobile banking app. Scenario 600 shows that the chatbot has provided response 603 based on applying an AI model to input 601. Response 603 includes target transaction 605.

The AI model may have selected target transaction 605 for display based on a recent transaction history for a user that includes transactions associated with a vendor called retail_2. The AI model may have selected target transaction 605 for display based on a transaction description typically associated with searches performed by the user in connection with a vendor called retail_2. The AI model may have selected target transaction 605 based on any suitable activity of the user.

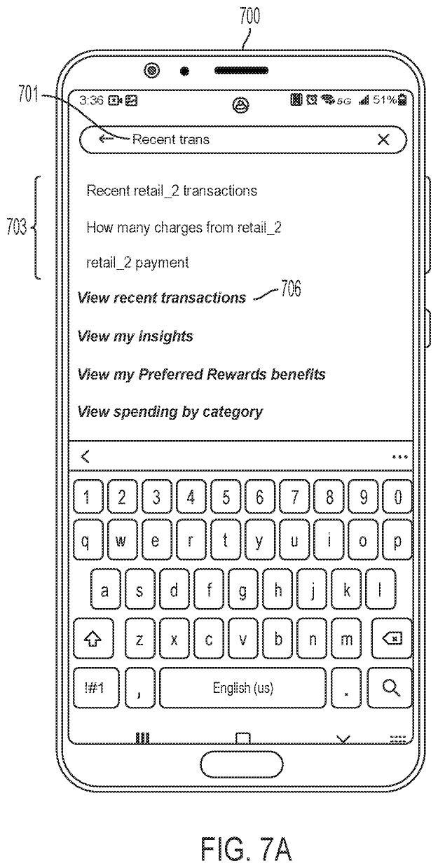

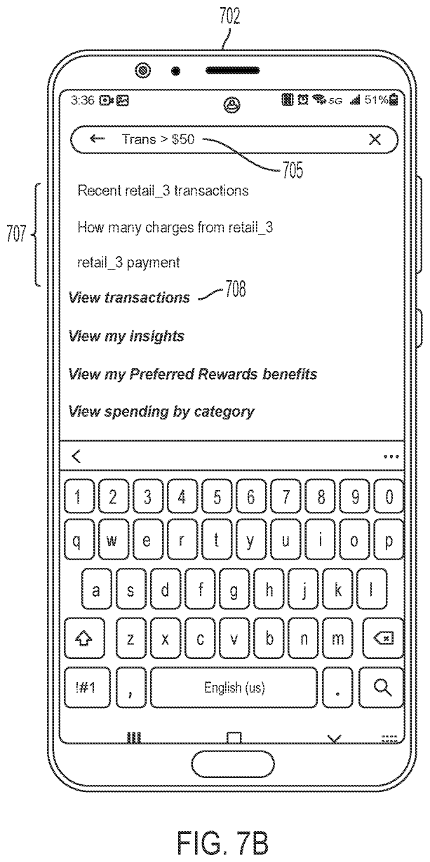

FIG. 7A shows illustrative scenario 700. In scenario 700, a user has entered characters 701 into search function 301. Characters 701 includes a text string “recent trans.” A prior-art search function (e.g., shown in FIG. 4) may have provided a user a link to function 706 for viewing recent transactions. The user would then have to identify a specific account or enter other filtering criteria to locate the desired recent transactions.

However, scenario 700 shows that the AI system described herein provides smart search results 703. Smart search results 703 are specific to recent transactions or other functionality associated with target vendor retail_2. Although the user has not included any reference to retail_2 in characters 701, the AI system has determined, based on training data, that the user is most likely interested in recent transactions associated with retail_2.

FIG. 7B shows illustrative scenario 702. In scenario 702, a user has entered characters 705 into search function 301. Characters 705 includes text string “trans>$50.” A prior-art search function (e.g., shown in FIG. 4) may have provided a user a link to function 708 for viewing transactions. The user would then have to identify a specific account or enter other filtering criteria to locate the desired transactions.

However, scenario 702 shows that the AI system described herein provides smart search results 707. Smart search results 707 are specific to transactions or other functionality associated with target vendor retail 3. Although the user has not included any reference to retail 3 in characters 705, the AI system has determined, based on training data, that the user is most likely interested in transactions for over $50 associated with retail 3. For example, the user may have previously executed a threshold number of searches for transactions conducted with retail 3.

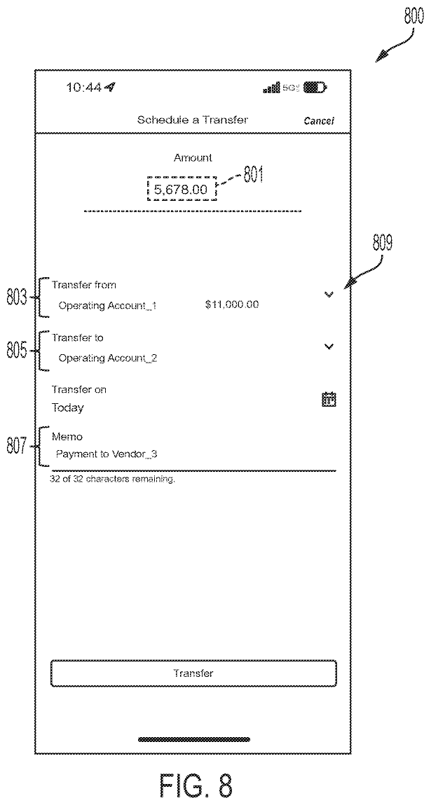

FIG. 8 shows illustrative smart search result 800.

Search result 800 may be generated by an AI system described herein in response to a user search for “recent trans” (input 701, shown in FIG. 7A). In response to detecting that a user has searched for “recent trans,” the AI system may determine that on this day of the month, the user typically searches for recent transactions and then executes a payment to vendor 3. The AI system may therefore, in response to the entry of input 701 on the relevant day of the month, direct the user to landing page 809.

Landing page 809 shows that the AI system has already pre-filled amount 801, source account 803, destination account 805 and memo field 807. The information entered into landing page 809 may also be determined based on user activity or other training data provided to the AI system.

Thus, apparatus and methods for an ARTIFICIAL INTELLIGENCE SMART AUTOCOMPLETE are provided. Persons skilled in the art will appreciate that the present disclosure can be practiced by other than the described embodiments, which are presented for purposes of illustration rather than of limitation. The present disclosure is limited only by the claims that follow.

What is claimed is:

1. An artificial intelligence (“AI”) system for responding to a query submitted by a user, the system comprising machine executable instructions, that when executed by a processor on a computer system:
track activity of the user within an application;
based on the activity of the user, formulate a set of training data comprising a plurality of input terms and a plurality of function labels;
train an AI model based on the training data;
detect user entry of a search string into a search function within the application;
apply the AI model to present a target output to the user, the target output comprising:
at least one of the plurality of input terms in response to detecting that the search string begins with one of the plurality of function labels; and
at least one of the plurality of function labels in response to detecting that the search string begins with one of the plurality of input terms.

2. The system of claim 1 wherein the set of training data is created based on tracking user navigation within the application during a predetermined time period.

3. The system of claim 1 wherein the training data comprises a frequency of use associated with each of the plurality of input terms and the AI model utilizes the frequency when generating the target output.

4. The system of claim 1 wherein the training data comprises a frequency of use associated with each of the plurality of function labels and the AI model utilizes the frequency when generating the target output.

5. The system of claim 1 wherein the system displays at least one of the functional labels and an input associated with the at least one of the functional labels.

6. The system of claim 1 wherein the target output comprises presenting an input screen within the application, the input screen associated with the at least one of the plurality of function labels.

7. The system of claim 6 the system comprising machine executable instructions, when executed by the processor, pre-fill the input screen using at least one of the one of the plurality of input terms.

8. An artificial intelligence (“AI”) system for auto-completing user intent based on entry of a search term into a search function by a user, the system comprising machine executable instructions, that when executed by a processor on a computer system:
track user activity within an application during a training period;
formulate a set of training data based on the user activity;
using the training data, train an AI model to link user input provided to the application to a function implemented by the application;
detect entry of the search term into the search function;
apply the AI model to the search term and generate a target function implemented by the application, wherein a description of the target function within the application does not include the search term; and
present the target function to the user within a user interface of the application.

9. The system of claim 8, wherein the user activity comprises:
navigation within the application to locate a plurality of functions provided by the application;
an execution frequency associated with each of the plurality of functions; and
text strings entered into the application by the user when interacting with the plurality of functions provided by the application.

10. The system of claim 8, wherein the machine executable instructions, when executed by the processor on the computer system, in response to generating the target function:
navigate to an input screen of the target function within the application, wherein the input screen provides an interface for entering an input value associated with the target function; and
based on the search term, pre-fill at least one input value into the input screen.

11. The system of claim 9, wherein the machine executable instructions, when executed by the processor on the computer system further:
detect a change in the execution frequency associated with the target function implemented by the application; and
in response to detecting the change in frequency, initiate a new training period.

12. The system of claim 8, wherein the machine executable instructions, when executed by the processor on the computer system further dynamically reapply the AI model to the search term in response to each additional character added by the user to the search term.

13. The system of claim 8, wherein a descriptive label associated with the target function is a text string that does not begin with a first letter of the search term.

14. The system of claim 13 the descriptive label does not include the search term anywhere in the text string.

15. The system of claim 8, wherein the application is a first application and the machine executable instructions, when executed by the processor on the computer system:
formulate the set of training data based on user activity associated with the first application and a second application; and
train the AI model to generate the target function implemented by the first application based on correlating the search term to the user activity associated with the second application.

16. An artificial intelligence (“AI”) method for generating smart search results in response to a search string entered by a user, the method comprising:
tracking activity of the user within an application;
building a user profile based on the activity of the user;
detecting entry of the search string;
based on the user profile:
locating a target function implemented by the application;
opening a landing page within the application that provides access to the target function; and
prefilling at least one field on the landing page based on the user profile.

17. The AI method of claim 16 wherein the application is a first application:
the tracking of the activity of the user comprises tracking:
a first set of user activity comprising first user inputs entered into the first application and first outputs generated by the first application in response to the first user inputs; and
a second set of user activity comprising second user inputs entered into a second application and second outputs generated by the second application in response to the second user inputs;
building the user profile based on the first set of user activity and the second set of user activity; and
locating the target function implemented by the first application based on the second set of user activity.

18. The method of claim 17, wherein the first set of user activity is associated with a first user and the second set of user activity is associated with a second user.

19. The method of claim 17 wherein the search string is a numeric value and based on the user profile locating the target function implemented by the application.

20. The method of claim 17 further comprising:
applying an artificial intelligence (“AI”) model to monitor the user profile; and
in response to detecting a threshold change in the activity of the user regenerating the user profile.
